(19) United States
(12) Patent Application Publication
(10) Pub. No.: US 2026/0158422 A1
(43) Pub. Date: Jun. 11, 2026

(54) PETROLEUM SELF-CLEANING FILTRATION DEVICE AND COMPOSITE PUMPING JOINT

(71) Applicant: Shaanxi Yinhe Petroleum Engineering Technology Services Ltd., Xi'an (CN)

(72) Inventor: Chunjun Yang, Xi'an (CN)

(21) Appl. No.: 19/416,070

(22) Filed: Dec. 11, 2025

(30) Foreign Application Priority Data
Dec. 11, 2024 (CN) 202411817417.7

(51) Int. Cl. B01D 29/64; B01D 29/94

(52) U.S. Cl. CPC B01D 29/6476; B01D 29/94; B01D 2221/04

(57) ABSTRACT

A self-cleaning oil filtration device and a composite pumping joint are provided, and the self-cleaning oil filtration device includes a shell. One end of the shell is provided with a crude oil inlet, and the other end is provided with an oil outlet. The crude oil inlet is connected to the oil outlet of an oil pump through a pipeline. A beam-type pump drives the oil pump through the composite pumping joint, and the oil outlet is connected to a storage tank; an oil filtering mechanism is provided inside the shell and configured to filter crude oil; a slag discharge port is provided through the corresponding oil filtering mechanism of the shell, and a filter slag collection bin is clamped and sealed on the slag discharge port; a scraper is further provided inside the slag discharge port. The oil filtering mechanism can automatically complete its own cleaning.

### CROSS-REFERENCE TO RELATED APPLICATIONS

This application claims priority to Chinese Patent Application No. 202411817417.7, filed on Dec. 11, 2024, which is hereby incorporated by reference in its entirety.

### TECHNICAL FIELD

The present disclosure relates to the field of oil filtration technologies, and in particular, to a petroleum self-cleaning filtration device and a composite pumping joint.

### BACKGROUND

Oil, one of the core objects of geological exploration, is a viscous and dark brown liquid known as the “lifeline of industry”. It mainly occurs in shallow areas of the Earth's crust, with a complex composition composed of numerous alkanes, cycloalkanes, and aromatic hydrocarbons. Petroleum is not only the main source of fuels such as fuel and gasoline, but also plays a key role as a raw material for various products in the chemical industry, including areas such as solvents, fertilizers, pesticides, and plastics. However, crude oil extracted from underground is often mixed with impurities and foreign substances, and must undergo a process of filtering out impurities to obtain pure petroleum products. In the existing oil filtration and extraction equipment, there are the following problems.
1. The real-time filtration equipment for oil cannot achieve automatic cleaning, and usually needs to complete another stage of filtration and manually remove the filter screen for active cleaning. The manual cleaning method is not only cumbersome, but also reduces the overall efficiency of filtration.
2. The filtration state and cleaning time of the filter cannot be accurately controlled. Frequent cleaning can easily cause excessive wear on the filter, and untimely cleaning can lead to poor oil filtration efficiency.
3. During operation, there are problems such as the disconnection of the sucker rod joint and the torsion fracture of the sucker rod, as well as the issue of being susceptible to corrosion.

In response to the above problems, the present disclosure provides a petroleum self-cleaning filtration device and a composite pumping joint to solve aforementioned problems.

### SUMMARY

To achieve the above objectives, the present disclosure provides the following technical solution: a petroleum self-cleaning filtration device, including: a shell, one end of the shell is provided with a crude oil inlet and the other end thereof is provided with an oil outlet, the crude oil inlet is connected to the outlet of the oil pump through a pipeline, a beam-type oil pump drives the oil pump through a composite pumping joint, and the oil outlet is connected to a storage tank;
an oil filtering mechanism configured to filter crude oil is mounted inside the shell;
a slag discharge port is penetrated through the shell corresponding to the oil filtering mechanism, and a filter slag collection bin is clamped and sealed on the slag discharge port; a scraper is further provided inside the slag discharge port.

In some embodiments of the present disclosure, the oil filtering mechanism includes: an oil guide valve port, and the oil guide valve port is fixedly provided at one end of the shell adjacent to the crude oil inlet, and an adjustment ring is provided on the shell through the oil guide valve port and shell sliding seal, and an adjustment spring is provided between the adjustment ring and the oil guide valve port;
two control components are symmetrically provided inside the shell, with one end connected to the adjustment ring and the other end connected to one end of the oil filtration component, and the oil filtration component is provided inside the shell;
a fixing bracket is fixedly provided inside the shell and connected to the other end of the oil filtration component.

In some embodiments of the present disclosure, the oil filtration component includes a ring frame, and the ring frame is slidably provided inside the shell, a bearing is fixedly provided at an axis of the ring frame, a nut is coaxially provided through the bearing, and a scraper plate is fixedly provided on the nut;
a lead-screw is fixedly provided on the fixing bracket, and the lead-screw is also threaded with the nut;
two locking hooks are symmetrically fixed on the ring frame and clamped with the control component.

In some embodiments of the present disclosure, the oil filtration component further includes: a filter residue temporary storage box, a filter screen, a sealing sleeve ring, and a compression spring;
the filter residue temporary storage box is fixedly provided on the ring frame; the filter screen is fixedly provided on the ring frame;
the sealing sleeve ring is fixedly provided on the shell configured to cooperate with the ring frame to achieve sealing;
the compression spring is sleeved on the lead-screw, with one end connected to the fixing bracket and the other end connected to the ring frame.

In some embodiments of the present disclosure, the control component includes a fixing ring, and the fixing ring is fixedly provided on the shell, and a rotatable seat is fixedly provided on the fixing ring corresponding to the locking hook;
an adjustment rod is rotatably provided on the rotatable seat, with one end engaged with the locking hook and the other end rotatably provided on one end of the telescopic adjuster;
the other end of the telescopic adjuster is rotatably provided on the adjustment ring.

In some embodiments of the present disclosure, the filter residue temporary storage box includes a filter residue box, and the filter residue box is fixedly provided on the ring frame, and a base plate is rotatably provided at a bottom of one end of the filter residue box away from the ring frame.

A composite pumping joint, including a sucker rod, a sleeve joint, an inner sleeve, a connection head, and the petroleum self-cleaning filtration device;
one end of the connection head is connected to an oil pump of the oil self-cleaning filtration device, and the other end is disassembled and connected to the sleeve joint through internal threads, and a surface of the connection head is treated with multi-element alloy co-cementation technology;
the inner sleeve is fixedly provided inside the sleeve joint, and an outer wall of the inner sleeve has a conical structure, with three arc-shaped platforms provided inside;
the arc-shaped platforms are used for clamping the sucker rod tightly, a torque relief device, a coupling, and a centralizer processed by multi-element alloy co-cementation technology are provided on the sucker rod, and the coupling is used for connecting and separating sucker rods of different quantities and specifications;
the torque relief device is configured to absorb, disperse, and reduce torque and stress generated by a reciprocating motion of a driving equipment; the centralizer is configured to straighten and prevent eccentric wear of the sucker rod.

In some embodiments of the present disclosure, the sucker rod is made of fiber-reinforced composite material; after an overall processing of the inner sleeve is completed, it is divided into two halves at an axial center position with a certain gap.

Compared with the existing technology, the present disclosure provides a petroleum self-cleaning filtration device and a composite pumping joint, which have the following beneficial effects as follows.
1. During the process of crude oil filtration, the impurities adhering to the oil filtration mechanism gradually increase, resulting in a gradual decrease in filtration efficiency. At this time, when the filtration efficiency gradually decreases and is less than the production efficiency of the oil pump, the filtration mechanism relatively expands the storage space, thereby maintaining the production efficiency of the oil pump. When a maximum storage space of the filtering mechanism is reached, the filtering mechanism automatically cleans the impurities adhering to it. After cleaning, the impurities are scraped off by a scraper through the slag discharge port and dropped into the filter slag collection bin for storage, thereby achieving self-cleaning of the filter screen during the process of filtering crude oil and improving the overall efficiency of crude oil filtration.
2. When the oil filter mechanism reaches the cleaning conditions, it automatically cleans the filter screen to avoid excessive cleaning causing wear and tear on the filter screen, as well as a decrease in filtration efficiency due to untimely cleaning.
3. The outer wall of the inner sleeve and the inner wall of the sleeve joint have the same taper and high surface finish. At the same time, the arc-shaped platforms provided in the inner sleeve clamping the sucker rod tightly, which synchronously moves the inner sleeve towards a lower end of the sleeve joint when the sucker rod is subjected to axial tension, thereby converting an axial tension into a radial locking force. This locking force will further enhance the mechanical locking effect of the arc-shaped platforms on the sucker rod, and the stronger the axial tension, the better the mechanical locking effect.

### BRIEF DESCRIPTION OF DRAWINGS

FIG. 1 is a schematic diagram of a petroleum self-cleaning filtration device.

FIG. 2 is an enlarged schematic structural diagram of part A of the petroleum self-cleaning filtration device.

FIG. 3 is a schematic diagram of a connection of a filtration component of the petroleum self-cleaning filtration device.

FIG. 4 is an enlarged schematic structural diagram of part B of the petroleum self-cleaning filtration device.

FIG. 5 is an enlarged schematic structural diagram of part C of the petroleum self-cleaning filtration device.

FIG. 6 is an enlarged schematic structural diagram of part D of the petroleum self-cleaning filtration device.

FIG. 7 is a schematic diagram of a slag discharge port of the petroleum self-cleaning filtration device.

FIG. 8 is a schematic diagram of an internal structural connection of a composite pumping joint.

FIG. 9 is a schematic diagram of an inner sleeve structure of the composite pumping joint.

FIG. 10 is a schematic top view of the inner sleeve of the composite pumping joint.

FIG. 11 is a schematic structural diagram of the composite pumping joint.

FIG. 12 is a schematic top view of the composite pumping joint.

Numeral reference: 1—shell; 2—crude oil inlet; 4—oil outlet; 5—filter slag collection bin; 61—sucker rod; 62—sleeve joint; 63—inner sleeve; 64—connection head; 7—oil filtering mechanism; 71—oil guide valve port; 72—adjustment ring; 73—adjustment spring; 74—control component; 741—fixing ring; 742—rotatable seat; 743—adjustment rod; 745—telescopic adjuster; 75—oil filtration component; 751—ring frame; 752—lead-screw; 753—locking hook; 754—nut; 755—filter residue temporary storage box; 7551—filter residue box; 7552—base plate; 756—bearing; 757—filter screen; 758—scraper plate; 759—sealing sleeve ring; 7510—compression spring; 76—fixing bracket; 8—slag discharge port; 9—scraper.

### DESCRIPTION OF EMBODIMENTS

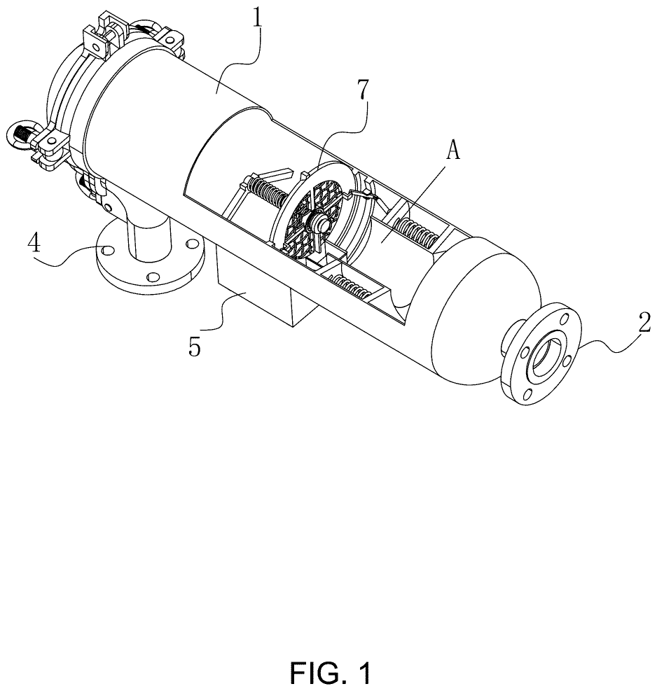

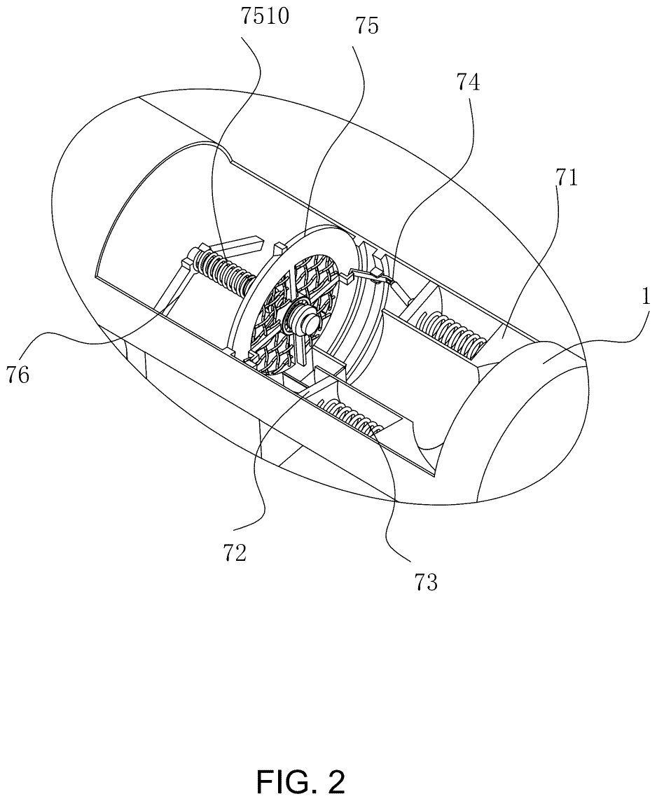

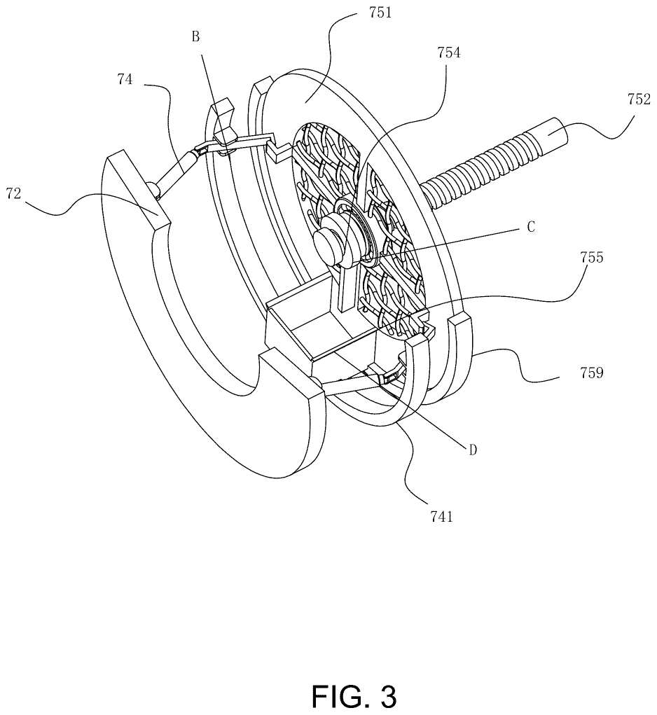

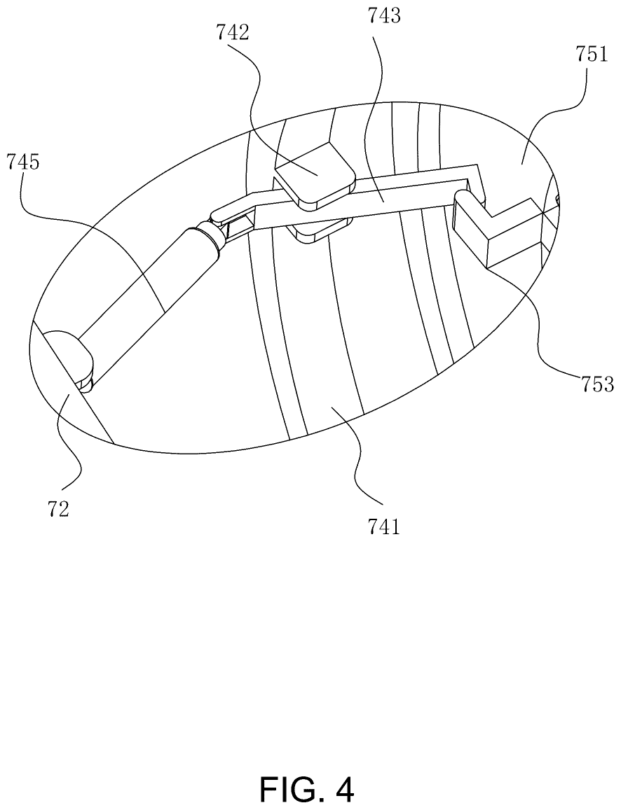

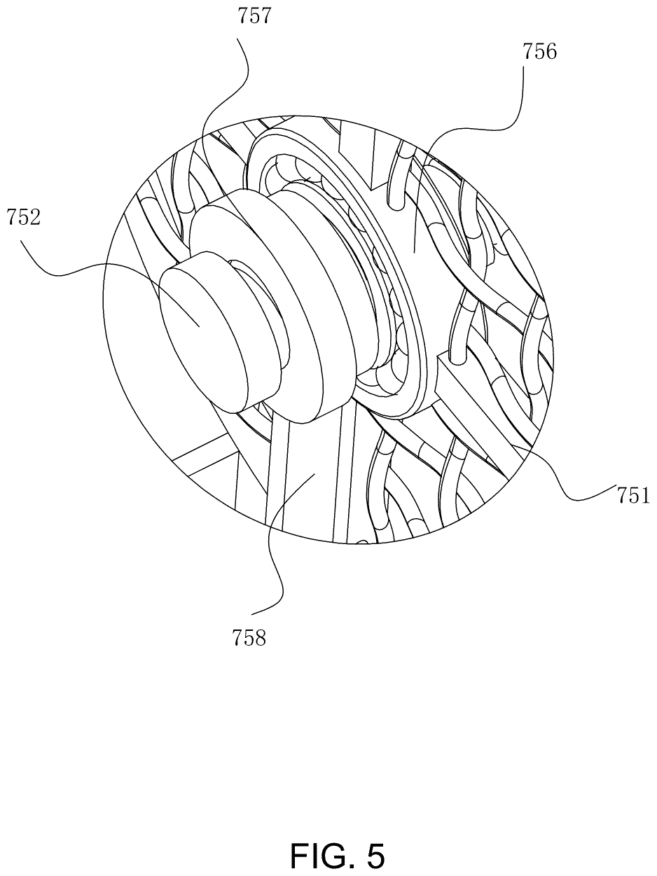

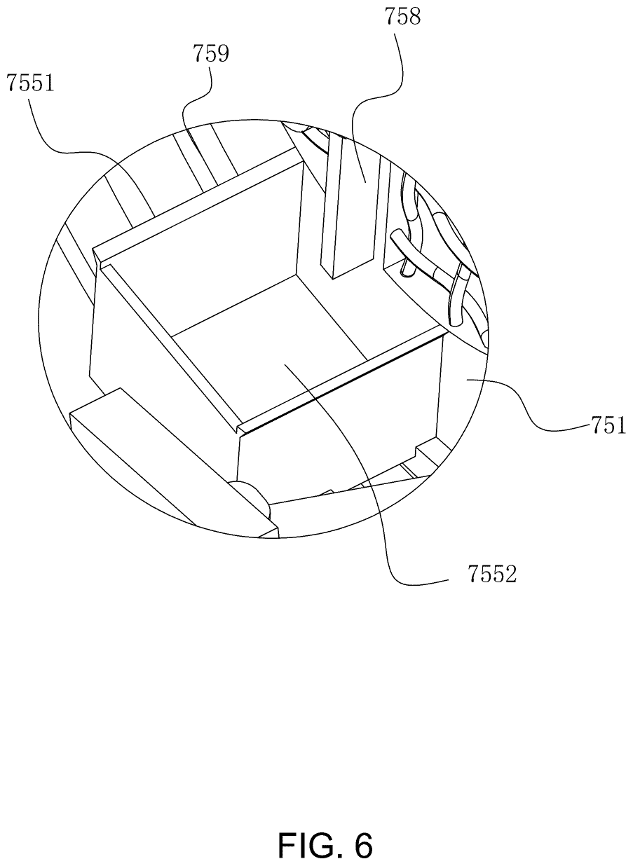

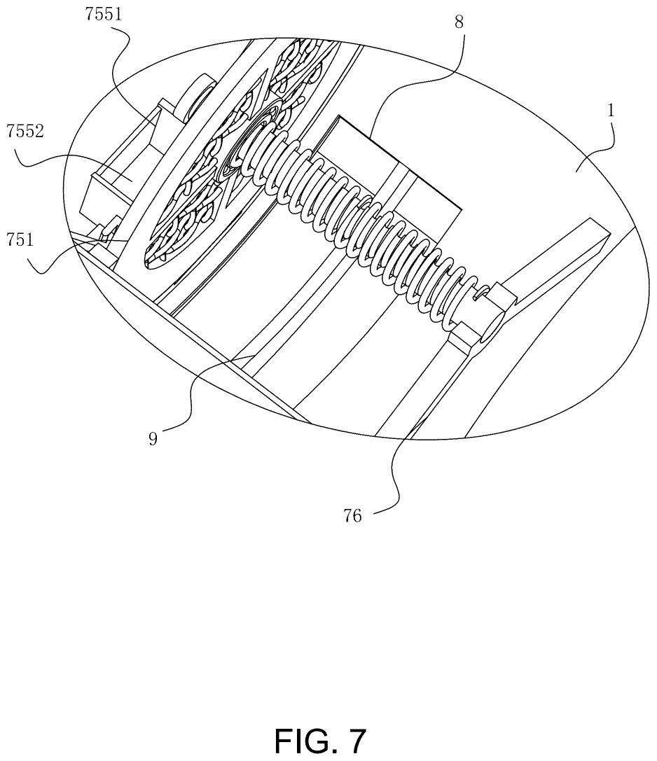

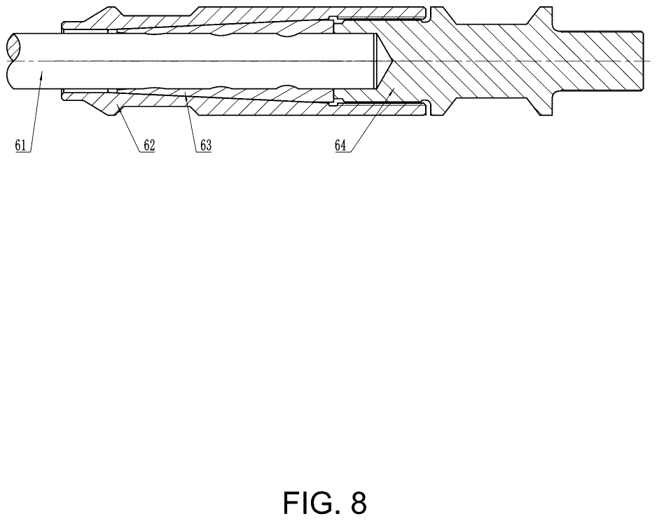

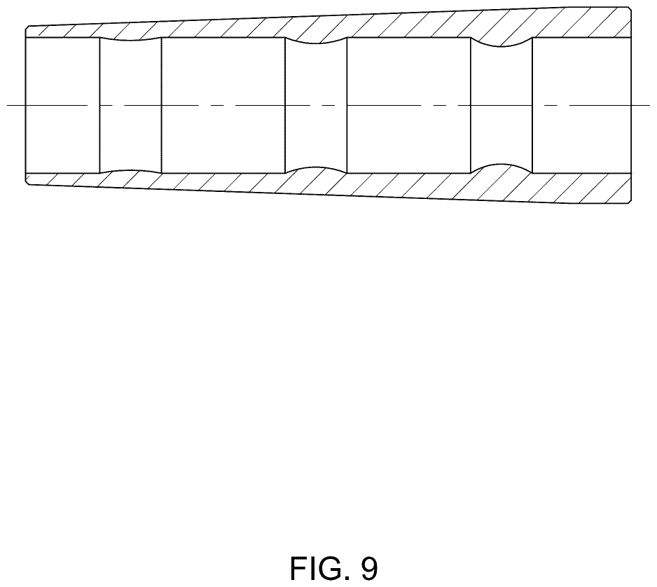

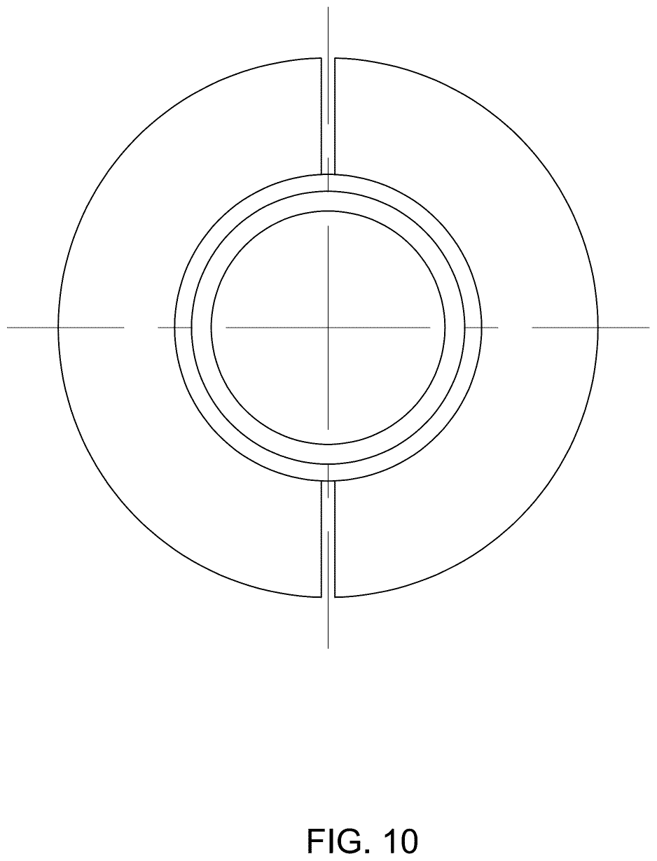

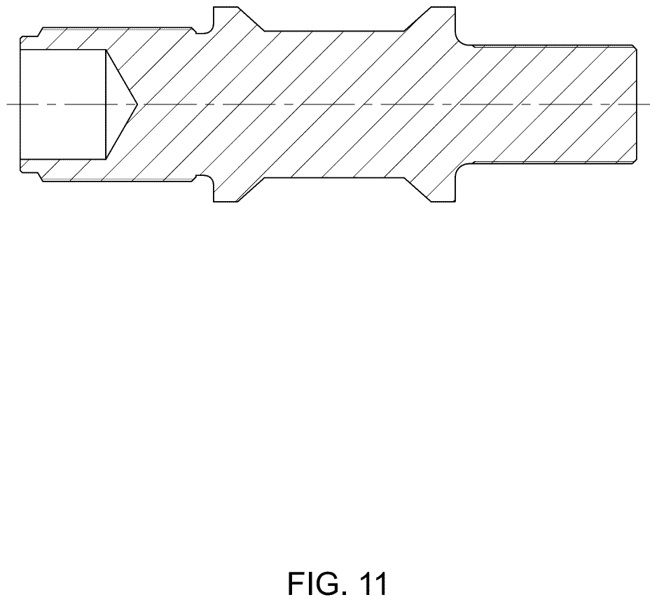

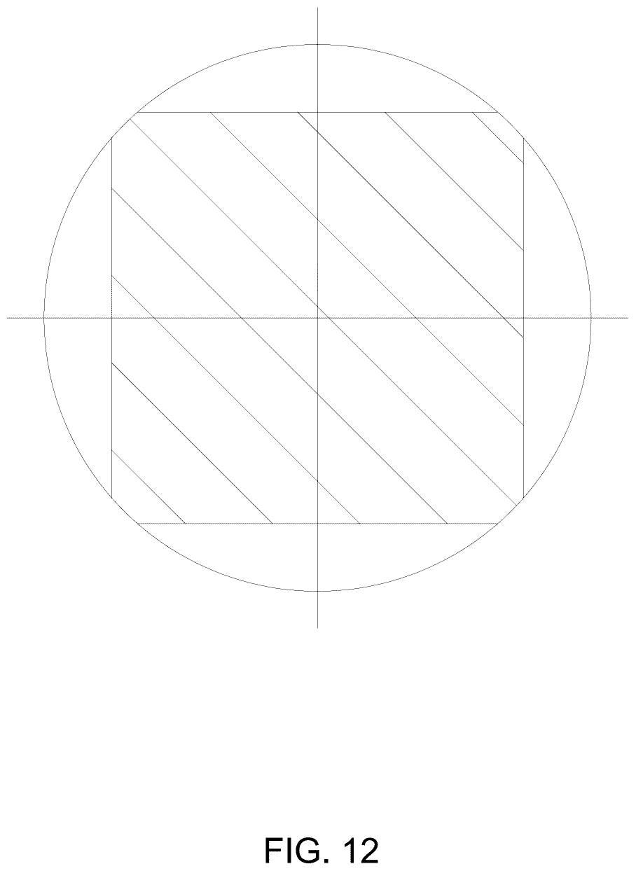

Referring to FIGS. 1-12, the present disclosure provides a technical solution: a petroleum self-cleaning filtration device, including: a shell 1, one end of the shell 1 is provided with a crude oil inlet 2, and the other end thereof is provided with an oil outlet 4. The crude oil inlet 2 is connected to an oil outlet of an oil pump through a pipeline, a beam-type oil pump drives the oil pump through a composite oil pump joint, and the oil outlet 4 is connected to a storage tank.

An oil filtering mechanism 7 is mounted inside shell 1, and is used for filtering crude oil; a slag discharge port 8 is penetrated through the shell 1 corresponding to the oil filtering mechanism 7, and a filter slag collection bin 5 is clamped and sealed on the slag discharge port 8; a scraper 9 is further provided inside the slag discharge port 8.

Start the beam type pump, it drives the oil pump to extract rock crude oil through the composite pumping joint. The crude oil extracted by the oil pump flows into the shell 1 through the crude oil inlet 2 and the pipeline. At this time, the crude oil is filtered by the oil filtering mechanism 7 to remove impurities. The filtered crude oil flows through the oil outlet 4 to the storage tank for storage.

During a process of filtering crude oil by the oil filtering mechanism 7, the impurities adhering to the oil filtering mechanism 7 will gradually increase, resulting in a gradual decrease in filtration efficiency. At this time, when the filtration efficiency gradually decreases and is less than an extraction efficiency of the oil pump, the oil filtering mechanism 7 will gradually expand the storage space. When the maximum storage space of the oil filtering mechanism 7 is reached, the oil filtering mechanism 7 automatically cleans the impurities adhered to it. After cleaning, the impurities are scraped off by the scraper 9 and stored in the filter slag collection bin 5 when passing through the slag discharge port 8.

After the self-cleaning of the oil filtering mechanism 7 is completed, an initial filtering state is restored, and the above process is repeated to continuously filter impurities in the crude oil extracted by the oil pump, ensuring real-time filtering of the extracted crude oil. This not only reduces the impurity in crude oil, but also improves the efficiency of crude oil extraction and subsequent processing.

In an implementation mode, the oil filtering mechanism 7 includes an oil guide valve port 71, and the oil guide valve port 71 is fixedly provided at one end of the shell 1 adjacent to the crude oil inlet 2, and an adjustment ring 72 is arranged through the oil guide valve port 71 and on the shell 1 sliding seal. An adjustment spring 73 is provided between the adjustment ring 72 and the oil guide valve port 71.

Two control components 74 are symmetrically mounted inside the shell 1, with one end connected to the adjustment ring 72 and the other end connected to one end of the oil filtration component 75, and the oil filtration component 75 is mounted inside the shell 1.

A fixing bracket 76 is fixed inside shell 1 and connected to the other end of the oil filtration component 75.

It should be explained that the crude oil entering the shell 1 flows through the oil guide valve port 71 to the oil filtration component 75, and under the action of the oil filtration component 75, impurities in the crude oil are filtered.

When the impurities adhering to the oil filtration component 75 gradually increase, resulting in a filtration efficiency lower than the production efficiency of the oil pump, the continuous entry of crude oil causes the adjustment ring 72 to slide towards one side closer to the crude oil inlet 2, thereby increasing the storage space. When the adjustment ring 72 slides, it compresses the adjustment spring 73 and adjusts the state of the control component 74. When the storage space gradually approaches its limit, the continued entry of crude oil causes the adjustment ring 72 to continue sliding, thereby changing a connection state between the control component 74 and the oil filtration component 75. When the storage space reaches its limit (the adjustment ring 72 slides to its limit), the connection state between the control component 74 and the oil filtration component 75 is released. Under the action of the adjustment spring 73, the adjustment ring 72 pushes the crude oil to act on the oil filtration component 75, so that the oil filtration component 75 self-cleans the impurities adhered to it. After completing the self-cleaning of impurities, the oil filtration component 75 returns to its initial state and is reconnected to the control component 74.

In an implementation mode, the oil filtration component 75 includes a ring frame 751, and the ring frame 751 is slidably provided inside the shell 1. A bearing 756 is fixedly provided at an axis of the ring frame 751, and a nut 754 is coaxially provided through the bearing 756. A scraper plate 758 is fixedly provided on the nut 754, and a limit platform is further provided on the ring frame 751, and the limit platform is in contact with the shell 1 to limit a rotation of the ring frame 751.

A lead-screw 752 is fixedly provided on the fixing bracket 76, and is also threaded with the nut 754.

Two locking hooks 753 are symmetrically fixed on the ring frame 751 and clamped with the control component 74.

In an implementation mode, the oil filtration component 75 further includes: a filter residue temporary storage box 755, a filter screen 757, a sealing sleeve ring 759, and a compression spring 7510.

The filter residue temporary storage box 755 is fixedly provided on the ring frame 751; the filter screen 757 is fixedly provided on the ring frame 751. The sealing sleeve ring 759 is fixedly provided on the shell 1, and is configured to cooperate with the ring frame 751 to achieve sealing.

The compression spring 7510 is provided on the lead-screw 752, with one end connected to the fixing bracket 76 and the other end connected to the ring frame 751.

It should be noted that the filter screen 757 filters impurities in crude oil, and the impurities adhere to the filter screen 757 under the action of crude oil, resulting in impurities gradually blocking a mesh of the filter screen 757 during crude oil filtration, leading to a gradual decrease in a filtration efficiency of the filter screen 757 for crude oil.

When the efficiency of the filter screen 757 in filtering crude oil is lower than the pumping efficiency of the oil pump, the unfiltered portion of the crude oil will act on the adjustment ring 72, causing it to slide to increase the storage space. At the same time, the movement of the adjustment ring 72 will gradually compress the adjustment spring 73 and change the state of the control component 74. As the adjustment ring 72 gradually slides to its limit position (the oil storage space gradually reaches its limit), the continued movement of the adjustment ring 72 will cause the control component 74 to gradually deflect. When the adjustment ring 72 reaches the limit sliding position, a deflection of the control component 74 will cause it to disengage from the locking hook 753, thereby sliding the ring frame 751 and the filter screen 757 inside the shell 1 through crude oil under the action of the adjustment spring 73.

When the ring frame 751 slides, the nut 754 starts to rotate under the action of the lead-screw 752. The rotation of the nut 754 causes the scraper plate 758 to rotate and scrape off the impurities adhered to the surface of the filter screen 757. At the same time, the sliding distance of the ring frame 751 precisely causes the scraper plate 758 to rotate on the filter screen 757 for a full number of turns, that is, after the scraping is completed, the scraper plate 758 will stay at its initial position.

After completing the cleaning of impurities adhering to the surface of the filter screen 757, the scraper plate 758 will concentrate and accumulate above the filter residue temporary storage box 755. More impurities will gradually flow into the filter residue temporary storage box 755 for collection under the action of gravity.

When cleaning impurities on the filter screen 757, the sliding of the ring frame 751 will compress the compression spring 7510. After the scraper plate 758 completes the removal of impurities on the filter screen 757, the elastic force generated by the compression spring 7510 can restore the ring frame 751 to its initial state and establish a connection between the locking hook 753 and the control component 74.

In an implementation mode, the control component 74 includes a fixing ring 741, and the fixing ring 741 is fixedly provided on the shell 1. A rotatable seat 742 is fixedly provided on the fixing ring 741 corresponding to the locking hook 753.

The adjustment rod 743 is rotatably provided on the rotatable seat 742, with one end clamped with the locking hook 753 and the other end rotatably provided on one end of the telescopic adjuster 745. The other end of the telescopic adjuster 745 is rotatably provided on the adjustment ring 72.

It should be noted that during the movement of the adjustment ring 72, a length of the telescopic adjuster 745 will adaptively change. When the telescopic adjuster 745 reaches the limit state where the length cannot be changed, the continued movement of the adjustment ring 72 will cause the telescopic adjuster 745 to pull the adjustment lever 743 and make it rotate. When the adjustment ring 72 moves to the limit position, the rotation angle of the adjustment lever 743 will cause it to disconnect from the locking hook 753, that is, release the position limit of the ring frame 751, so that the ring frame 751 can use the adjustment ring 72 and crude oil to push the ring frame 751 under the action of the adjustment spring 73, to complete the self-cleaning effect of the filter screen 757.

After the self-cleaning of filter screen 757 is completed, during the process of restoring the initial state through the compression spring 7510, the locking hook 753 is connected to the adjustment rod 743, thereby restoring the position limitation of the ring frame 751.

It should be noted that a torsion spring is provided at a rotational connection axis between the rotatable seat 742 and the adjustment lever 743. The torsion spring is configured to maintain a deflection angle between the adjustment lever 743 and the rotatable seat 742, so that the locking hook 753 can be re-established the connection relationship when disconnecting from the adjustment rod 743

[symbol]

In an implementation mode, the filter residue temporary storage box 755 includes a filter residue box 7551, and the filter residue box 7551 is fixedly mounted on the ring frame 751. A base plate 7552 is rotatably provided at a bottom of the filter residue box 7551 at one end away from the ring frame 751.

It should be noted that during the self-cleaning process of the filter screen 757, the sliding of the ring frame 751 will drive the filter residue box 7551 to move. After the filter residue box 7551 separates from the sealing sleeve ring 759, the temporarily stored filter residue inside will rotate the base plate 7552 under the action of gravity, so that when the base plate 7552 comes into contact with the scraper 9, it will scrape off the adhered impurities on the base-plate 7552 and ultimately cause the impurities to fall into the filter slag collection bin 5 for storage.

When the ring frame 751 returns to its initial state, the base plate 7552 rotates under the action of the sealing sleeve ring 759 and docks with the filter residue box 7551.

A composite pumping joint, including a sucker rod 61, a sleeve joint 62, an inner sleeve 63, a connection head 64, and the petroleum self-cleaning filtration device.

One end of connection head 64 is connected to the oil pump of the self-cleaning oil filtration device, and the other end is disassembled and connected to sleeve joint 62 through internal threads. A surface of the connection head 64 is treated with multi-element alloy co-cementation technology.

An inner sleeve 63 is fixedly provided inside the sleeve joint 62. An outer wall of the inner sleeve 63 has a conical structure, and there are three arc-shaped platforms provided inside. The arc-shape platforms are configured to clamp the sucker rod 61 tightly. A torque relief device, a coupling, and a centralizer processed by multi-element alloy co-cementation technology are provided on the sucker rod 61. The coupling is used for connecting and separating sucker rods 61 of different quantities and specifications.

The torque relief device is configured to absorb, disperse, and reduce the torque and stress generated by a reciprocating motion of a driving equipment. The centralizer is configured to straighten and prevent eccentric wear of the sucker rod 61.

In an implementation mode, the sucker rod 61 is made of fiber-reinforced composite material and is formed by one-time extrusion and heat curing, with a maximum tensile force of 32-35 tons; after an overall processing of the inner sleeve 63 is completed, it is divided into two halves at an axial center position with a certain gap.

An outer wall of the inner sleeve 63 has the same taper as an inner wall of the sleeve joint 62, and the surface smoothness requirement is high. Therefore, under the action of tension, the inner sleeve 63 moves towards a small end of the sleeve joint 62, converting an axial tension into a radial force to clamp the sucker rod 61, and the clamping force increases with the increase of axial force. Under the action of the arc-shaped platforms of the inner sleeve 63, the sucker rod 61 is tightened.

In specific implementation, the beam-type pump is started to drive the oil pump through the composite pumping joint. The oil pump pumps the extracted crude oil into the shell 1 through the crude oil inlet 2. The oil filtration component 75 filters the impurities in the pumped crude oil. During the continuous impurity filtering process, the filtering efficiency of the oil filtration component 75 gradually decreases due to the adhesion of impurities. When the filtration limit is reached, the oil filtration component 75 undergoes self-cleaning under the action of the adjustment spring 73, and the impurities generated after cleaning are discharged into the filter slag collection bin 5. After self-cleaning, the oil filtration component 75 returns to its initial state and continues to filter the extracted crude oil.

The above is only preferred specific embodiment of the present disclosure, but the protection scope of the present disclosure is not limited to this. Any skilled person familiar with the technical field should be included in the protection scope of the present disclosure by equivalent substitution or modification based on the technical solution and inventive concept disclosed in the present disclosure.

What is claimed is:

1. A petroleum self-cleaning filtration device, comprising: a shell, one end of the shell is provided with a crude oil inlet and the other end thereof is provided with an oil outlet, the crude oil inlet is connected to an oil outlet of an oil pump through a pipeline, a beam-type oil pump drives the oil pump through a composite pumping joint, and the oil outlet is connected to a storage tank;
an oil filtering mechanism configured to filter crude oil is mounted inside the shell;
a slag discharge port is penetrated through the shell corresponding to the oil filtering mechanism, and a filter slag collection bin is clamped and sealed on the slag discharge port; a scraper is further provided inside the slag discharge port;
wherein the oil filtering mechanism comprises an oil guide valve port, and the oil guide valve port is fixedly provided at one end of the shell adjacent to the crude oil inlet, and an adjustment ring is provided on the shell through the oil guide valve port and shell sliding seal, and an adjustment spring is provided between the adjustment ring and the oil guide valve port;
two control components are symmetrically provided inside the shell, with one end connected to the adjustment ring and the other end thereof connected to one end of the oil filtration component, and the oil filtration component is provided inside the shell;
a fixing bracket is fixedly provided inside the shell and connected to the other end of the oil filtration component;
wherein the oil filtration component comprises a ring frame, and the ring frame is slidably provided inside the shell, a bearing is fixedly provided at an axis of the ring frame, a nut is coaxially provided through the bearing, and a scraper plate is fixedly provided on the nut;
a lead-screw is fixedly provided on the fixing bracket, and the lead-screw is also threaded with the nut;
two locking hooks are symmetrically fixed on the ring frame and clamped with the control component;
wherein the oil filtration component further comprises: a filter residue temporary storage box, a filter screen, a sealing sleeve ring, and a compression spring;
the filter residue temporary storage box is fixedly provided on the ring frame; the filter screen is fixedly provided on the ring frame;
the sealing sleeve ring is fixedly provided on the shell configured to cooperate with the ring frame to achieve sealing;
the compression spring is sleeved on the lead-screw, with one end connected to the fixing bracket and the other end connected to the ring frame;
wherein the control component comprises a fixing ring, and the fixing ring is fixedly provided on the shell, and a rotatable seat is fixedly provided on the fixing ring corresponding to the locking hook;
an adjustment rod is rotatably provided on the rotatable seat, with one end engaged with the locking hook and the other end rotatably provided on one end of the telescopic adjuster;
the other end of the telescopic adjuster is rotatably provided on the adjustment ring;
wherein the filter residue temporary storage box comprises a filter residue box, and the filter residue box is fixedly provided on the ring frame, and a base plate is rotatably provided at a bottom of one end of the filter residue box away from the ring frame.

2. A composite pumping joint, comprising a sucker rod, a sleeve joint, an inner sleeve, a connection head, and the petroleum self-cleaning filtration device according to claim 1;
one end of the connection head is connected to an oil pump of the oil self-cleaning filtration device, and the other end is disassembled and connected to the sleeve joint through internal threads, and a surface of the connection head is treated with multi-element alloy co-cementation technology;
the inner sleeve is fixedly provided inside the sleeve joint, and an outer wall of the inner sleeve has a conical structure, with three arc-shaped platforms provided inside;
the arc-shaped platforms are used for clamping the sucker rod tightly, a torque relief device, a coupling, and a centralizer processed by multi-element alloy co-cementation technology are provided on the sucker rod, and the coupling is used for connecting and separating sucker rods of different quantities and specifications;
the torque relief device is configured to absorb, disperse, and reduce torque and stress generated by a reciprocating motion of a driving equipment; the centralizer is configured to straighten and prevent eccentric wear of the sucker rod.

3. The composite pumping joint according to claim 2, wherein the sucker rod is made of fiber-reinforced composite material; after an overall processing of the inner sleeve is completed, it is divided into two halves at an axial center position with a certain gap.
